(19) United States
(12) Patent Application Publication
(10) Pub. No.: US 2014/0090546 A1
(43) Pub. Date: Apr. 3, 2014

(54) SYSTEM, APPARATUS AND METHOD FOR FOOT-OPERATED EFFECTS

(71) Applicants: Gianfranco Ceccolini, Sao Paulo (BR); Rosa Alexandre Leite, Sao Paulo (BR); Ladeira Rodrigo Tadeu de Oliveira, Sao paulo (BR)

(72) Inventors: Gianfranco Ceccolini, Sao Paulo (BR); Rosa Alexandre Leite, Sao Paulo (BR); Ladeira Rodrigo Tadeu de Oliveira, Sao paulo (BR)

(21) Appl. No.: 14/110,911

(22) PCT Filed: Apr. 11, 2012
(86) PCT No.: PCT/BR12/00107

§ 371 Date: Dec. 18, 2013

(30) Foreign Application Priority Data
Apr. 14, 2011 (BR) MU 9100858-1

(51) Int. Cl. G10H 1/02

(52) U.S. Cl. CPC G10H 1/02
USPC 84/626

(57) ABSTRACT

A foot-operated pedal for programming audio and other effects, including an HMI or Human-Machine Interface that digitally communicates with a CPU, providing the parameters of effects set by the user, where a PC Interface is responsible for the mediation of the communication between the CPU and an external computer used to program the settings and adjustments of the device, with the audio interface having the function of promoting the compatibility between the electrical signal from the musical instrument and the CPU.

### FIELD OF THE INVENTION

The present invention is directed to a device designed to provide special effects and distortions on audio signals from musical instruments and microphones, allowing the configuration and recording of different effects, encapsulated in the form of plug-ins, directly on the device herein identified as a foot-operated pedal.

### BACKGROUND OF THE INVENTION

Foot-operated pedals employed for distortion are well known among musicians, becoming popular since the 70s. The prior art discusses that the effects able to be produced are unlimited, but common pedals are only able to store a limited set of effects therein, i.e., the pedals known up to today are unable to contain a plethora of effects in order to adapt to the personal preferences of each musician or to meet diverse needs.

Currently, one of the drawbacks with respect to conventional pedals concerns the limitation of the audio effects stored on a same device, which ultimately limit the musical possibilities of the users, forcing them to acquire more than one pedal to obtain the desired effects or close to what they desire.

As an alternative to confer greater flexibility for possible effects, several software programs for PCs have emerged, capable of programming different effects and distortions by connecting the PC to microphones and musical devices, such as electric guitars, for example. A drawback of this configuration, however, is the low portability of the set, and its low robustness, as compared to the pedals when subjected to the hostile environment of the stage, where vibrations and relatively high temperatures are common.

The transformation of PCs into specific hardware devices is not new and there are many applications in the market, for example, current data network routers, multimedia stations, and video game consoles, among other applications.

Along the same lines, recently, some initiatives have emerged that aim at providing “programmable” pedals, using proprietary programming languages, such as VST (Virtual Studio Technology) plug-ins, as noted in the description of U.S. Patent Application Publication No. US2010/0269670, published on Oct. 28, 2010, which although an improvement continues to restrict the creative options of users since adding new effects binds them to the purchase of a software license (VST).

Accordingly, one of the goals of the instant invention lies in providing a solution to the aforementioned drawbacks, being able to confer the portability of the current pedals associated with the total flexibility of programming of PCs, and also the convenience provided by the use of open programming standards and languages available to users so that they can program, configure, parameterize and write their own effects in a single pedal, exempting them from acquiring more than one device or software usage license, and giving them complete freedom of musical creation through a single device.

### SUMMARY OF THE INVENTION

The present invention is directed to an improved foot-operated pedal for programming audio and other effects, including an HMI or Human-Machine Interface that digitally communicates with a CPU, providing the parameters of effects set by the user, where a PC Interface is responsible for the mediation of the communication between the CPU and an external computer used to program the settings and adjustments of the device, with the audio interface having the function of promoting the compatibility between the electrical signal from the musical instrument and the CPU.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying DRAWINGS, where like reference numerals designate like structural and other elements, in which:

FIG. 1 illustrates an architecture diagram of the proposed device pursuant to the principles of the present invention;

FIG. 2 illustrates a perspective view of the fully assembled pedal as shown in FIG. 1;

FIG. 3 illustrates a perspective view of an open pedal configuration, where the positioning of the CPU can be seen;

FIG. 4 illustrates a perspective view of the open pedal configuration, where the positioning of the HMI can be seen; and

FIG. 5 illustrates a posterior view of the pedal, where the positioning of the PC Interface and Audio Interface can be seen.

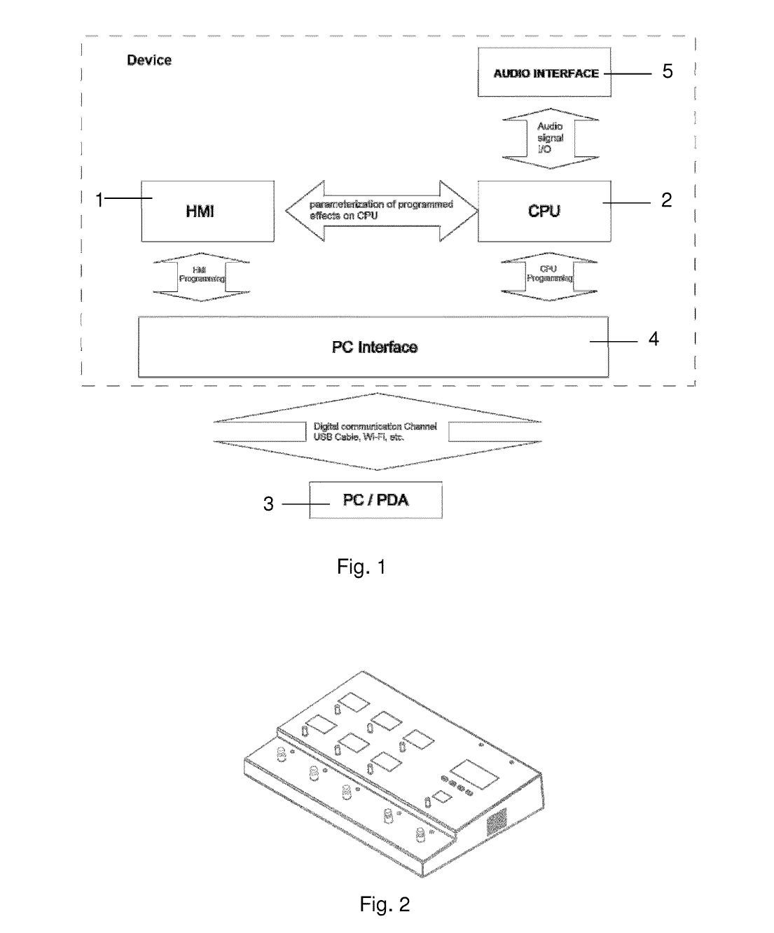

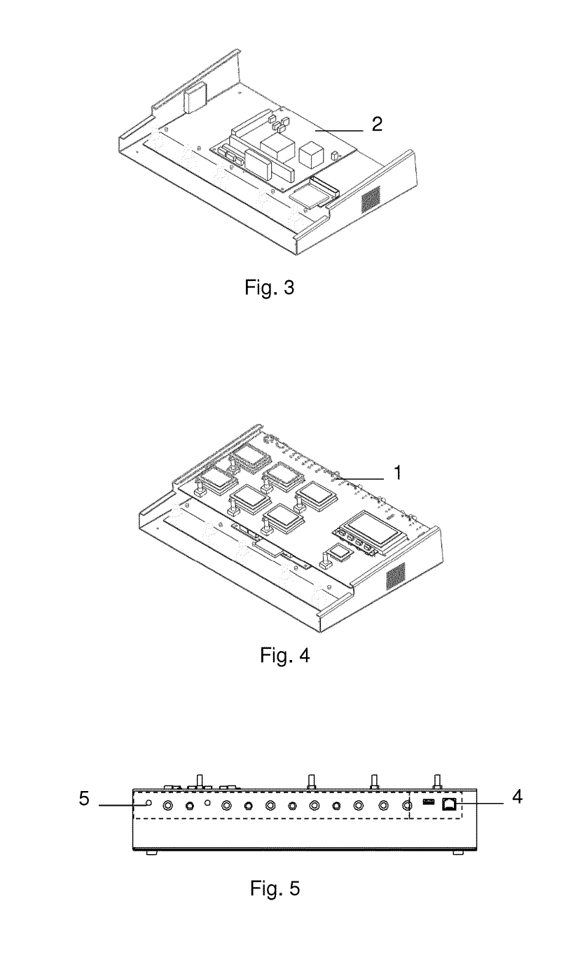

### DETAILED DESCRIPTION OF THE PRESENT INVENTION

The following detailed description is presented to enable any person skilled in the art to make and use the invention. For purposes of explanation, specific nomenclature is set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

As illustrated in the FIGURES, the foot-operated pedal for programmable distortion and audio effects of the present invention is preferably made by the assembled set according to the system architecture illustrated in FIG. 1 of the DRAWINGS, where an HMI—Human-Machine Interface, generally designated by the reference numeral 1, which replaces a mouse, keyboard and monitor, digitally communicates with a CPU, generally designated by the reference numeral 2, providing the parameters of effects set by the user.

A PC interface, generally designated by the reference numeral 4, mediates communication between the CPU 2 and an external computer, generally designated by the reference numeral 3, used to program the settings and adjustments of the device, as is understood in the art.

Additionally, an audio interface, generally designated by the reference numeral 5, performs the compatibility between the electrical signal from the musical instrument connected to the pedal and the CPU 2.

Preferred methods and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

1. A foot-operated effects device comprising:
a processor;
a human-machine interface; and
a memory,
wherein said memory contains a plurality of effects therein,
whereby a user may operate one or more of said plurality of effects by foot manipulation to said device.

2. The foot-operated effects device according to claim 1, further comprises:
a processor interface,
wherein said processor interface mediates communication between said processor and an external computer.

3. The foot-operated effects device according to claim 2, wherein said external computer is used to program settings and make adjustments to the device.

4. The foot-operated effects device according to claim 3, wherein external programming of audio effects from said external computer is utilized on said device.

5. The foot-operated effects device according to claim 3, wherein external programming of audio effects from said external computer is programmed directly into said memory.

6. The foot-operated effects device according to claim 1, wherein an open pattern of effects is employed on said device.

7. The foot-operated effects device according to claim 1, wherein an open software platform of interconnection of plug-ins of low latency is employed.

8. The foot-operated effects device according to claim 1, wherein said processor comprises one or more 32 or 64 bit processors.

9. The foot-operated effects device according to claim 1, wherein an open operational system, with quite optimized coding, is employed.

10. The foot-operated effects device according to claim 1, wherein said user, through an audio interface, can manipulate the gain adjustment and impedance of an external electrical signal to the device.
